(19) United States
(12) Patent Application Publication
(10) Pub. No.: US 2025/0366475 A1
(43) Pub. Date: Dec. 4, 2025

(54) HERBICIDAL COMBINATIONS AND A METHOD FOR CONTROLLING UNDESIRED VEGETATION

(71) Applicants: UPL Mauritius Limited, Port Louis (MU); UPL Europe Ltd., Cheshire (GB)

(72) Inventors: Giuvan Lenz, Pereiras (BR); Jessica Ferreira Lourenco Leal, Pereiras (BR); Ganesh Rao, Mumbai (IN)

(21) Appl. No.: 18/874,469

(22) PCT Filed: Jun. 15, 2023
(86) PCT No.: PCT/GB2023/051568

§ 371 Date: Dec. 12, 2024

(30) Foreign Application Priority Data
Jun. 16, 2022 (IN) 202211034574

(51) Int. Cl. A01N 57/20; A01N 43/68; A01P 13/00

(52) U.S. Cl. CPC A01N 57/20; A01N 43/68; A01P 13/00

(57) ABSTRACT

The present disclosure relates to a method for controlling unwanted vegetation/weeds. More particularly, the present disclosure relates to a method for controlling Brachiaria genus weeds with synergistic herbicidal combinations comprising L-glufosinate, salts, esters, or combinations thereof and at least one additional herbicide.

### FIELD OF THE DISCLOSURE

The present disclosure relates to a method of controlling undesired vegetation/weeds. More particularly, the present disclosure relates to a method of controlling Brachiaria genus weeds with synergistic herbicidal combinations and compositions comprising said combinations.

### BACKGROUND ART

Weeds are undesirable plants that are detrimental to agriculture and significantly affect crop yields. Farmers use various types of herbicides to control weeds. Herbicides are chemical substances, which are used to specifically control the unwanted plants/weeds.

Brachiaria decumbens is a perennial plant, much tillered, upright and about 30 to 100 centimetres (cm) tall. Its reproduction occurs through seeds, rhizomes and stolons. Its seeds can present viability for up to 8 years; majority among which present initial dormancy and can germinate at several depths (about 0 to 8 cm). This species is difficult to control, due to the irregular and prolonged germination of the seeds. It is reported that in areas infested with Brachiaria decumbens, there may be up to 82% yield reduction in crops. As a consequence of its characteristics, its control in pre-emergence requires a herbicide with long effective period of (residual) control. In such cases, an effective herbicidal combination may hold some potential for good control over this weed. The herbicides, solo or combinations presently known are not sufficient to control resistant and persistent Brachiaria genus weeds, for example Brachiaria decumbens.

There is a constant need to develop effective herbicidal combinations to control the growth of unwanted plants/weeds. Furthermore, selective control of unwanted plants/weeds in crops is a key challenge facing modern agriculture, as the herbicides may not always result in the desired effect. Combinations of herbicides may result in an additive effect or an antagonistic effect. It may also result in phytotoxicity to the crops making it an undesirable combination. Consequently, herbicides need to be carefully selected so that they can be combined to offer a synergistic effect that would control weeds while having no phytotoxic effect on the crop and reduce the chances of the weeds developing resistance to a particular herbicide.

Therefore, there is a need in the art for a method of protecting crops from Brachiaria genus weeds using herbicidal combinations that have advantageous properties such as being synergistic, helping in resistance management, reducing dosage of herbicides used and providing improved residual effects.

### OBJECTIVES OF THE DISCLOSURE

It is a primary objective of the present disclosure to provide a method of controlling Brachiaria genus weeds by applying a herbicidal combination.

It is another objective of the present disclosure to provide a method of controlling Brachiaria genus weeds, by applying a synergistic herbicidal combination comprising L-glufosinate, salts, esters, or combinations thereof and at least one additional herbicide.

It is yet another objective of the present disclosure to provide a method of controlling Brachiaria genus weeds, by applying a synergistic herbicidal combination comprising L-glufosinate, salts, esters, or combinations thereof and at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

It is yet another objective of the present disclosure to provide a method of controlling Brachiaria genus weeds in plants, wherein the method comprises applying a synergistic herbicidal combination comprising L-glufosinate, salts, esters, or combinations thereof and at least one additional herbicide, to a plant or a locus thereof, where undesirable vegetation occurs or is expected to occur.

It is yet another objective of the present disclosure to provide a method of increasing yield in a plant by application of a synergistic herbicidal combination.

It is yet another objective of the present disclosure to provide a method of improving the plant health by application of a synergistic herbicidal combination.

### SUMMARY OF THE DISCLOSURE

In an aspect, there is provided a synergistic herbicidal combination for control of Brachiaria genus weeds, said combination comprising L-glufosinate, salts, esters, or combinations thereof and at least one additional herbicide.

In another aspect, there is provided a synergistic herbicidal combination for control of Brachiaria genus weeds, said combination comprising L-glufosinate, salts, esters, or combinations thereof and at least one additional herbicide selected from the group comprising:
(a) cellulose synthesis inhibitor herbicides;
(b) very-long-chain fatty acid (VLCFA) inhibitor herbicides;
(c) hydroxyphenyl pyruvate dioxygenase (HPPD) inhibitor herbicides;
(d) acetyl CoA carboxylase (ACC) inhibitor herbicides;
(e) herbicides with unknown mode of action;
or combinations thereof.

In another aspect, there is provided an herbicidal composition for controlling Brachiaria genus weeds, wherein the composition comprises:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof, and
(c) at least one agrochemically acceptable excipient.

In another aspect, there is provided use of a synergistic herbicidal combination for controlling Brachiaria genus weeds, wherein said combination comprises:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

In an aspect, the present disclosure provides a method of controlling Brachiaria genus weeds, said method comprising applying to a plant or a locus thereof at which control is desired, a synergistic herbicidal combination comprising L-glufosinate, salts, esters, or combinations thereof and at least one additional herbicide.

In another aspect, there is provided a method of controlling Brachiaria genus weeds, said method comprising applying to a plant or a locus thereof at which control is desired, a synergistic herbicidal combination comprising:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

### DETAILED DESCRIPTION OF THE DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

For the purposes of the following detailed description, it is to be understood that the disclosure may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”.

Unless otherwise defined, all technical and scientific terms used herein have the same meaning as commonly understood by one of ordinary skill in the art to which this disclosure pertains. In the case of conflict, the present document, including definitions will control. Although methods and materials similar or equivalent to those described herein can be used in the practice or testing of the disclosure, suitable methods and materials are described herein.

It is to be noted that, as used in the specification, the singular forms “a”, “an”, and “the” include plural referents unless the context clearly dictates otherwise.

The expression of various quantities in terms of “%” or “% w/w” means the percentage by weight of the total solution or composition unless otherwise specified.

The terms “comprising”, “having”, “including”, and “containing” are to be construed as open-ended terms (i.e., meaning “including, but not limited to”) unless otherwise noted.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The term “herbicide” as used herein denotes a compound which controls or modifies the growth of undesired weeds.

The term “herbicidally effective amount” indicates the quantity of such a compound or combination of such compounds which is capable of controlling or modifying effect on the growth of harmful plants. Controlling effects include all deviation from natural development, for example: killing, retardation, leaf burn, albinism, dwarfing, etc.

The term “plants” refers to all physical parts of a plant, including seeds, seedlings, saplings, roots, tubers, stems, stalks, foliage and fruits.

The term “locus” refers to an area of planted crops or a location where Brachiaria genus weeds occurs or grows or can occur or grow and is intended to include soil, medium of growth other than soil.

As used herein, the terms “undesirable vegetation”, “undesirable species”, “undesirable plants”, “harmful plants”, “undesirable weeds”, “harmful weeds” or “weed” are synonyms and particularly refer to Brachiaria genus and species.

The terms “g a.i./L” as used herein denotes the concentration of the respective active ingredient in “grams” present “per litre” of the composition. The terms “g ai/L”, “g a.i./L” and “g/L” may be used interchangeably.

The terms “g a.i./ha” as used herein denotes the concentration of the respective active ingredient in “grams” applied “per hectare” of the crop field. The terms “g ai/ha”, “g a.i./ha” and “g/ha” may be used interchangeably.

As used herein, the term “inorganic salt” refers to salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, —NH₂(CH₃)(C₂H₄OH)⁺ salt, glufosinate-ammonium, glufosinate-sodium, glufosinate-potassium, glufosinate-calcium, or combinations thereof.

As used herein, the term “about” refers to a measurable value such as a parameter, an amount, a temporal duration, and the like and is meant to include variations of ±15% or less, specifically variations of ±10% or less, more specifically variations of ±5% or less, even more specifically variations of ±1% or less, and still more specifically variations of ±0.1% or less of and from the particularly recited value, in so far as such variations are appropriate to perform in the disclosure described herein. Furthermore, it is also to be understood that the value to which the modifier “about” refers is itself specifically disclosed herein.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents or adjuvants or excipients not specifically recited therein.

The term “control” relates to a weed, includes control of the weed, as well as protecting a plant, a portion of the plant, or a plant seed from attack or invasion by said weed.

As used herein, the term “pre-emergence” or “before emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

Glufosinate (also known as phosphinothricin; DL-homoalanin-4-yl(methyl)phosphinic acid) is a racemic phosphinico amino acid (Hoerlein, G. 1994; Glufosinate (Phosphinothricin), a natural amino acid with unexpected herbicidal properties. Rev. of Environmental Contamination and Toxicology 138, 73-145). Its ammonium salt (glufosinate-ammonium) is widely used as a non-selective herbicide. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The chemical structures of D-glufosinate and L-glufosinate are represented as below.

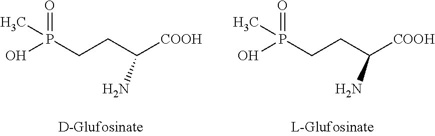

As used herein, the term “glufosinate” refers to any molecule which is a racemic phosphinico amino acid. The term also includes salts, forms such as solvates, hydrates, anhydrous form, crystalline form, polymorph forms, pseudo polymorph forms, amorphous form or mixture thereof, and sodium, potassium or ammonium salts. The salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include glufosinate-ammonium, glufosinate-sodium, glufosinate-potassium, or combinations thereof.

As used herein, the term “L-glufosinate” refers to the L-isomer of Glufosinate, a salt and an ester thereof. The L-enantiomer of glufosinate acts by inhibition of glutamine synthetase thereby causing accumulation of toxic levels of ammonium ion and indirectly stopping photosynthesis. It is also known as phosphinothricin or (S)-2-amino-4-(hydroxy(methyl)phosphonyl)butanoic acid. The term can generically refer to any form of L-glufosinate such as solvates, hydrates, esters, anhydrous form, polymorph forms, pseudo polymorph forms, amorphous form or mixture thereof, and sodium, potassium or ammonium salts. The salts of 1-glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agronomically acceptable salts include L-glufosinate-ammonium, L-glufosinate-sodium, and L-glufosinate-potassium. The term may also refer to an isomeric (racemic) mixture of L-glufosinate, D-glufosinate and salts thereof, wherein the content of L-glufosinate in the mixture is 70% or greater, preferably 80% or greater and more preferably 90% or greater. Typically, the ratio of L-glufosinate:D-glufosinate can be in the range from about 90:10 to about 99.9:0.1, preferably from about 95:5 to about 99.9:0.1.

Brachiaria genus weeds means all the species falling within genus Brachiaria in the family Poaceae and comprise species such as Brachiaria africana, weedy Brachiaria coracana, Brachiaria floccifolia, Brachiaria decumbens, Brachiaria intermedia, Brachiaria jaegeri, Brachiaria kigeziensis, Brachiaria multiflora, Brachiaria semisterilis, Brachiaria tristachya, or combinations thereof.

Discussed below are some representative embodiments of the present disclosure. The disclosure in its broader aspects is not limited to the specific details and representative methods. Illustrative examples are described in this section in connection with the embodiments and methods provided.

An effective weed control can be achieved by usage of herbicides appropriately. The activity of herbicides can be enhanced in various ways to achieve the maximum benefit. One of the ways is to use herbicides with different herbicidal combinations. However, identifying appropriate combinations, their agrochemical application rates, and ratio of the combinations is essential to achieve efficacious control, which is not straight forward.

Accordingly, the present disclosure provides a method for partially or completely controlling harmful weeds with a combination of two or more herbicides.

Accordingly, the present disclosure provides a method for partially or completely controlling harmful weeds with a herbicidal combination.

Accordingly in an embodiment, the present disclosure provides a herbicidal combination.

In another embodiment, the present disclosure provides a herbicidal combination comprising L-glufosinate, salts, esters, or combinations thereof and at least one additional herbicide.

As used throughout the disclosure, L-glufosinate and the additional herbicide, includes their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

More particularly, the present disclosure provides a method of controlling weeds of Poaceae family with synergistic herbicidal combinations and compositions of said combinations.

In an aspect the present disclosure provides a method of controlling Brachiaria genus weeds with synergistic herbicidal combinations and compositions comprising said combinations.

It has been found by the inventors of the present invention that Brachiaria genus weeds can be controlled using a herbicidal combination comprising L-glufosinate, salts, esters, or combinations thereof and at least one additional herbicide selected from the group comprising:
(a) cellulose synthesis inhibitor herbicides;
(b) very-long-chain fatty acid (VLCFA) inhibitor herbicides;
(c) hydroxyphenyl pyruvate dioxygenase (HPPD) inhibitor herbicides;
(d) acetyl CoA carboxylase (ACC) inhibitor herbicides; and
(e) herbicides with unknown mode of action;
or combinations thereof.

It was found that in present combinations, L-glufosinate, salts, esters, or combinations thereof and at least one additional herbicide, provided a synergistic effect in controlling Brachiaria genus weeds. The degree of synergistic enhancement in the efficacy of the above combinations towards control of Brachiaria genus weeds was unpredictable and unexpected. Moreover, the properties and advantages mentioned are required in practical weed control in order to keep agricultural crops free of unwanted competing plants, and thus to qualitatively and quantitatively ensure and/or increase the yields in plants.

Accordingly, the present disclosure provides a method for partially or completely controlling harmful weeds with a synergistic herbicidal combination.

Accordingly, the present disclosure provides a method for partially or completely controlling Brachiaria genus weeds with a synergistic herbicidal combination.

Accordingly in an embodiment, the present disclosure provides a synergistic herbicidal combination.

In another embodiment, the present disclosure provides a synergistic herbicidal combination comprising L-glufosinate, salts, esters, or combinations thereof and at least one additional herbicide.

The present disclosure, therefore, provides a synergistic herbicidal combination for controlling Brachiaria genus weeds, wherein the combination comprises
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

In an embodiment, the salt comprises an inorganic salt of L-glufosinate.

In an embodiment, the inorganic salt of L-glufosinate is selected from the group comprising L-glufosinate sodium, L-glufosinate potassium, L-glufosinate ammonium, or combinations thereof. The inorganic salts of L-glufosinate can be selected from the group including monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt, or combinations thereof.

In an embodiment, the L-glufosinate salt is L-glufosinate ammonium.

In an embodiment, the L-glufosinate salt is L-glufosinate sodium.

In an embodiment, the L-glufosinate salt is L-glufosinate potassium.

In another embodiment, the present disclosure provides a herbicidal combination comprising L-glufosinate ammonium and at least one additional herbicide.

In another embodiment, the present disclosure provides a synergistic herbicidal combination comprising L-glufosinate ammonium and at least one additional herbicide.

In another embodiment, the present disclosure provides a synergistic herbicidal combination for controlling Brachiaria genus weeds, wherein the combination comprises L-glufosinate ammonium and at least one additional herbicide selected from the group comprising:
(a) cellulose synthesis inhibitor herbicides;
(b) very-long-chain fatty acid (VLCFA) inhibitor herbicides;
(c) hydroxyphenyl pyruvate dioxygenase (HPPD) inhibitor herbicides;
(d) acetyl CoA carboxylase (ACC) inhibitor herbicides; and
(e) herbicides with unknown mode of action;
or combinations thereof.

In an embodiment, the cellulose synthesis inhibitor herbicide is selected from one or more herbicides, or their salts, esters, isomers and combinations thereof listed in Table 1.

TABLE 1
Cellulose synthesis inhibitor herbicides

| | Chemical Class of Cellulose | Cellulose synthesis |
|---|---|---|
| Sr. No. | synthesis inhibitor herbicides | inhibitor herbicides |
| 1 | Alkylazines | Indaziflam |
| 2 | | Triaziflam |
| 3 | Benzamides | Isoxaben |
| 4 | Nitriles | Chlorthiamid |
| 5 | | Dichlobenil |
| 6 | Triazolocarboxamide | Flupoxam |

In an embodiment, the very-long-chain fatty acid (VLCFA) inhibitor herbicide is selected from one or more herbicides, or their salts, esters, isomers and combinations thereof listed in Table 2.

TABLE 2
Very-long-chain fatty acid (VLCFA) inhibitor herbicide

| | Chemical Class of Very-long-chain | Very-long-chain fatty |
|---|---|---|
| Sr. | fatty acid (VLCFA) inhibitor | acid (VLCFA) inhibitor |
| No. | herbicides | herbicides |
| 1 | Azolyl-carboxamides | Cafenstrole |
| 2 | | Fentrazamide |
| 3 | | Ipfencarbazone |
| 4 | Benzofurans | Benfuresate |
| 5 | | Ethofumesate |
| 6 | Isoxazolines | Fenoxasulfone |
| 7 | | Pyroxasulfone |
| 8 | Oxiranes | Indanofan |
| 9 | | Tridiphane |
| 10 | Thiocarbamates | Butylate |
| 11 | | Cycloate |
| 12 | | Dimepiperate |
| 13 | | S-ethyl |
| | | dipropylthiocarbamate |
| | | (EPTC) |
| 14 | | Esprocarb |
| 15 | | Molinate |
| 16 | | Orbencarb |
| 17 | | Pebulate |
| 18 | | Prosulfocarb |
| 19 | | Thiobencarb |
| 20 | | Tiocarbazil |
| 21 | | Tri-allate |
| 22 | | Vernolate |
| 23 | α-Chloroacetamides | Acetochlor |
| 24 | | Alachlor |
| 25 | | Allidochlor-CDAA |
| 26 | | Butachlor |
| 27 | | Butenachlor |
| 28 | | Delachlor |
| 29 | | Diethatyl-ethyl |
| 30 | | Dimethachlor |
| 31 | | Dimethenamid |
| 32 | | Metazachlor |
| 33 | | Metolachlor |
| 34 | | S-Metolachlor |
| 35 | | Pethoxamid |
| 36 | | Pretilachlor |
| 37 | | Propachlor |
| 38 | | Propisochlor |
| 39 | | Prynachlor |
| 40 | | Thenylchlor |
| 41 | α-Oxyacetamides | Flufenacet |
| 42 | | Mefenacet |
| 43 | α-Thioacetamides | Anilofos |
| 44 | | Piperophos |

In an embodiment, the hydroxyphenyl pyruvate dioxygenase (HPPD) inhibitor herbicide is selected from one or more herbicides, or their salts, esters, isomers and combinations thereof listed in Table 3.

TABLE 3
Hydroxyphenyl pyruvate dioxygenase (HPPD) inhibitor herbicide

| | Chemical Class of Hydroxyphenyl | Hydroxyphenyl pyruvate |
|---|---|---|
| Sr. | pyruvate dioxygenase (HPPD) | dioxygenase (HPPD) |
| No. | inhibitor herbicides | inhibitor herbicides |
| 1 | Isoxazoles | Isoxaflutole |
| 2 | Pyrazoles | Pyrasulfotole |
| 3 | | Tolpyralate |
| 4 | | Topramezone |
| 5 | Pyrazoles (procide) | Benzofenap |
| 6 | | Pyrazolynate |
| 7 | | Pyrazoxyfen |
| 8 | Triketones | Bicyclopyrone |
| 9 | | Fenquinotrione |
| 10 | | Mesotrione |
| 11 | | Sulcotrione |
| 12 | | Tefuryltrione |
| 13 | | Tembotrione |
| 14 | Triketones (procide) | Benzobicyclon |

In an embodiment, the acetyl CoA carboxylase (ACC) inhibitor herbicide is selected from one or more herbicides, or their salts, esters, isomers and combinations thereof listed in Table 4.

TABLE 4
Acetyl CoA carboxylase (ACC) inhibitor herbicides

| | Chemical Class of Acetyl COA | Acetyl COA carboxylase |
|---|---|---|
| Sr. | carboxylase (ACC) inhibitor | (ACC) inhibitor |
| No. | herbicides | herbicides |
| 1 | | Clodinafop-propargyl |
| 2 | Aryloxyphenoxy- | Clofop |
| 3 | propionates | Cyhalofop-butyl |
| 4 | | Diclofop-methyl |
| 5 | | Fenoxaprop-ethyl |
| 6 | | Fenthiaprop |
| 7 | | Fluazifop-butyl |
| 8 | | Haloxyfop-methyl |
| 9 | | Isoxapyrifop |
| 10 | | Metamifop |
| 11 | | Quizalofop-ethyl |
| 12 | | Quizalofop-p-tefuryl |
| 13 | Cyclohexanediones | Alloxydim |
| 14 | | Butroxydim |
| 15 | | Clethodim |
| 16 | | Cloproxydim |
| 17 | | Cycloxydim |
| 18 | | Profoxydim |
| 19 | | Sethoxydim |
| 20 | | Tepraloxydim |
| 21 | | Tralkoxydim |
| 22 | Phenylpyrazoline | Pinoxaden |

In an embodiment, the herbicide with unknown mode of action is selected from one or more herbicides, or their salts, esters, isomers and combinations thereof listed in Table 5.

TABLE 5
Herbicides with unknown mode of action

| Sr. | Chemical Class of Herbicides with | Herbicides with unknown |
|---|---|---|
| No. | unknown mode of action | mode of action |
| 1. | Acetamides | Diphenamid |
| 2. | | Naproanilide |
| 3. | | Naproanilide-M |
| 4. | | Napropamide |
| 5. | | Flamprop-m |
| 6. | | Napropamide -M |
| 7. | Arylaminopropionic acid | Tebutam |
| 8. | Benzamide | Dalapon |
| 9. | Chlorocarbonic acids | Flupropanate |
| 10. | | Trichloroacetic acid (TCA) |
| 11. | | Bromobutide |
| 12. | Phosphorodithioate | Bensulide |
| 13. | Rifluoromethane sulfonanilides | Mefluidide |
| 14. | | Perfluidone |
| 15. | Other | Calcium acid methanearsonate |
| | | (CAMA) |
| 16. | | Cacodylic acid |
| 17. | | Cumyluron |
| 18. | | Disodium methyl arsonate |
| | | (DSMA) |
| 19. | | Difenzoquat |
| 20. | | Dymron-Daimuron |
| 21. | | Etobenzanid |
| 22. | | Fosamine |
| 23. | | Monosodium methanearsonate |
| | | (MSMA) |
| 24. | | Methyldymron |
| 25. | | Monalide |
| 26. | | Oleic acid |
| 27. | | Oxaziclomefone |
| 28. | | Pelargonic acid |
| 29. | | Pyributicarb |
| 30. | | Quinoclamine |

In an embodiment, the present disclosure provides a method for controlling weeds by applying a synergistic herbicidal combination comprising L-glufosinate, salts, esters, or combinations thereof and at least one additional herbicide, wherein the additional herbicide comprises:
(a) a cellulose synthesis inhibitor herbicide comprising indaziflam;
(b) a very-long-chain fatty acid (VLCFA) inhibitor herbicide selected from the group comprising pyroxasulfone, propisochlor, metolachlor, S-metolachlor, or combinations thereof;
(c) a hydroxyphenyl pyruvate dioxygenase inhibitor herbicide selected from the group comprising isoxaflutole, mesotrione, tembotrione, or combinations thereof;
(d) an acetyl CoA carboxylase inhibitor herbicide selected from the group comprising quixalofop-ethyl, quizalifop-p-tefuryl, or combinations thereof; and
(e) a herbicide with unknown mode of action selected from the group comprising napropamide, napropamide-M, or combinations thereof.

In an embodiment, the present disclosure provides a synergistic herbicidal combination comprising L-glufosinate, salts, esters, or combinations thereof and at least one cellulose synthesis inhibitor herbicide for controlling Brachiaria genus weeds.

In an embodiment, the present disclosure provides a synergistic herbicidal combination comprising L-glufosinate ammonium and at least one cellulose synthesis inhibitor herbicide for controlling Brachiaria genus weeds.

In a preferred embodiment, the cellulose synthesis inhibitor herbicide is indaziflam.

In an embodiment, the present disclosure provides a synergistic herbicidal combination comprising L-glufosinate, salts, esters, or combinations thereof and indaziflam for controlling Brachiaria genus weeds.

In an embodiment, the present disclosure provides a synergistic herbicidal combination comprising L-glufosinate ammonium and indaziflam for controlling Brachiaria genus weeds.

In an embodiment, there is provided a synergistic herbicidal combination comprising L-glufosinate, salts, esters, or combinations thereof and at least one very-long-chain fatty acid (VLCFA) inhibitor herbicide for controlling Brachiaria genus weeds.

In an embodiment, there is provided a synergistic herbicidal combination comprising L-glufosinate ammonium and at least one very-long-chain fatty acid (VLCFA) inhibitor herbicide for controlling Brachiaria genus weeds.

In an embodiment, the very-long-chain fatty acid (VLCFA) inhibitor herbicide is pyroxasulfone.

In an embodiment, the very-long-chain fatty acid (VLCFA) inhibitor herbicide is propisochlor.

In an embodiment, the very-long-chain fatty acid (VLCFA) inhibitor herbicide is metolachlor or S-metolachlor.

In an embodiment, the very-long-chain fatty acid (VLCFA) inhibitor herbicide is metolachlor.

In an embodiment, the very-long-chain fatty acid (VLCFA) inhibitor herbicide is S-metolachlor.

In an embodiment, the present disclosure provides a synergistic herbicidal combination comprising L-glufosinate, salts, esters, or combinations thereof and pyroxasulfone for controlling Brachiaria genus weeds.

In an embodiment, the present disclosure provides a synergistic herbicidal combination comprising L-glufosinate ammonium and pyroxasulfone for controlling Brachiaria genus weeds.

In an embodiment, the present disclosure provides a synergistic herbicidal combination comprising L-glufosinate, salts, esters, or combinations thereof and propisochlor for controlling Brachiaria genus weeds.

In an embodiment, the present disclosure provides a synergistic herbicidal combination comprising L-glufosinate ammonium and propisochlor for controlling Brachiaria genus weeds.

In an embodiment, the present disclosure provides a synergistic herbicidal combination comprising L-glufosinate, salts, esters, or combinations thereof and metolachlor or S-metolachlor for controlling Brachiaria genus weeds.

In an embodiment, the present disclosure provides a synergistic herbicidal combination comprising L-glufosinate ammonium and metolachlor or S-metolachlor for controlling Brachiaria genus weeds.

In an embodiment, the present disclosure provides a synergistic herbicidal combination comprising L-glufosinate, salts, esters, or combinations thereof and metolachlor for controlling Brachiaria genus weeds.

In an embodiment, the present disclosure provides a synergistic herbicidal combination comprising L-glufosinate ammonium and metolachlor for controlling Brachiaria genus weeds.

In an embodiment, the present disclosure provides a synergistic herbicidal combination comprising L-glufosinate, salts, esters, or combinations thereof and S-metolachlor for controlling Brachiaria genus weeds.

In an embodiment, the present disclosure provides a synergistic herbicidal combination comprising L-glufosinate ammonium and S-metolachlor for controlling Brachiaria genus weeds.

In an embodiment, there is provided a synergistic herbicidal combination comprising L-glufosinate, salts, esters, or combinations thereof and at least one hydroxyphenyl pyruvate dioxygenase (HPPD) inhibitor herbicide for controlling Brachiaria genus weeds.

In an embodiment, there is provided a synergistic herbicidal combination comprising L-glufosinate ammonium and at least one hydroxyphenyl pyruvate dioxygenase (HPPD) inhibitor herbicide for controlling Brachiaria genus weeds.

In an embodiment, the hydroxyphenyl pyruvate dioxygenase (HPPD) inhibitor herbicide is isoxaflutole.

In an embodiment, the hydroxyphenyl pyruvate dioxygenase (HPPD) inhibitor herbicide is mesotrione.

In an embodiment, the hydroxyphenyl pyruvate dioxygenase (HPPD) inhibitor herbicide is tembotrione.

In an embodiment, the present disclosure provides a synergistic herbicidal combination comprising L-glufosinate, salts, esters, or combinations thereof and isoxaflutole for controlling Brachiaria genus weeds.

In an embodiment, the present disclosure provides a synergistic herbicidal combination comprising L-glufosinate ammonium and isoxaflutole for controlling Brachiaria genus weeds.

In an embodiment, the present disclosure provides a synergistic herbicidal combination comprising L-glufosinate, salts, esters, or combinations thereof and mesotrione for controlling Brachiaria genus weeds.

In an embodiment, the present disclosure provides a synergistic herbicidal combination comprising L-glufosinate ammonium and mesotrione for controlling Brachiaria genus weeds.

In an embodiment, the present disclosure provides a synergistic herbicidal combination comprising L-glufosinate, salts, esters, or combinations thereof and tembotrione for controlling Brachiaria genus weeds.

In an embodiment, the present disclosure provides a synergistic herbicidal combination comprising L-glufosinate ammonium and tembotrione for controlling Brachiaria genus weeds.

In an embodiment, there is provided a synergistic herbicidal combination comprising L-glufosinate, salts, esters, or combinations thereof and at least one acetyl CoA carboxylase (ACC) inhibitor herbicide for controlling Brachiaria genus weeds.

In an embodiment, there is provided a synergistic herbicidal combination comprising L-glufosinate ammonium and at least one acetyl CoA carboxylase (ACC) inhibitor herbicide for controlling Brachiaria genus weeds.

In an embodiment, the acetyl CoA carboxylase (ACC) inhibitor herbicide is quizalofop-ethyl.

In an embodiment, the acetyl CoA carboxylase (ACC) inhibitor herbicide is quizalofop-p-tefuryl.

In an embodiment, the present disclosure provides a synergistic herbicidal combination comprising L-glufosinate, salts, esters, or combinations thereof and quizalofop-ethyl for controlling Brachiaria genus weeds.

In an embodiment, the present disclosure provides a synergistic herbicidal combination comprising L-glufosinate ammonium and quizalofop-ethyl for controlling Brachiaria genus weeds.

In an embodiment, the present disclosure provides a synergistic herbicidal combination comprising L-glufosinate, salts, esters, or combinations thereof and quizalofop-p-tefuryl for controlling Brachiaria genus weeds.

In an embodiment, the present disclosure provides a synergistic herbicidal combination comprising L-glufosinate ammonium and quizalofop-p-tefuryl for controlling Brachiaria genus weeds.

Accordingly, there is provided a synergistic herbicidal combination comprising L-glufosinate, salts, esters, or combinations thereof and at least one herbicide with unknown mode of action for controlling Brachiaria genus weeds.

Accordingly, there is provided a synergistic herbicidal combination comprising L-glufosinate ammonium and at least one herbicide with unknown mode of action for controlling Brachiaria genus weeds.

In an embodiment, the herbicide with unknown mode of action is napropamide.

In another embodiment, the herbicide with unknown mode of action is napropamide-M.

In an embodiment, the present disclosure provides a synergistic herbicidal combination comprising L-glufosinate, salts, esters, or combinations thereof and napropamide for controlling Brachiaria genus weeds.

In an embodiment, the present disclosure provides a synergistic herbicidal combination comprising L-glufosinate ammonium and napropamide for controlling Brachiaria genus weeds.

In an embodiment, the present disclosure provides a synergistic herbicidal combination comprising L-glufosinate, salts, esters, or combinations thereof and napropamide-M for controlling Brachiaria genus weeds.

In an embodiment, the present disclosure provides a synergistic herbicidal combination comprising L-glufosinate ammonium and napropamide-M for controlling Brachiaria genus weeds.

In an embodiment, the present disclosure provides a synergistic herbicidal combination for control of Brachiaria genus weeds, the combination comprising L-glufosinate, salts, esters, or combinations thereof and at least one additional herbicide, wherein a weight ratio of L-glufosinate, salts, esters, or combinations thereof and at least one additional herbicide ranges from about 1:100 to about 100:1.

In a preferred embodiment, the weight ratio of L-glufosinate, salts, esters, or combinations thereof and at least one additional herbicide is selected from ratios comprising 1:1, 1:10, 1:20, 1:30, 1:40, 1:50, 1:60, 1:70, 1:80, 1:90 and 1:100.

In a preferred embodiment, the weight ratio of L-glufosinate, salts, esters, or combinations thereof and at least one additional herbicide is selected from ratios comprising 1:1, 10:1, 20:1, 30:1, 40:1, 50:1, 60:1, 70:1, 80:1, 90:1 and 100:1.

In an embodiment, the weight ratio of L-glufosinate, salts, esters, or combinations thereof and at least one cellulose synthesis inhibitor herbicide is in the range from about 1:100 to about 100:1.

In an embodiment, the weight ratio of L-glufosinate, salts, esters, or combinations thereof and at least one very-long-chain fatty acid inhibitor herbicide is in the range from about 1:100 to about 100:1.

In an embodiment, the weight ratio of L-glufosinate, salts, esters, or combinations thereof and at least one hydroxyphenyl pyruvate dioxygenase inhibitor herbicide is in the range from about 1:100 to about 100:1.

In an embodiment, the weight ratio of L-glufosinate, salts, esters, or combinations thereof and at least one acetyl CoA carboxylase inhibitor herbicide is in the range from about 1:100 to about 100:1.

In an embodiment, the weight ratio of L-glufosinate, salts, esters, or combinations thereof and at least one herbicide with unknown mode of action is in the range from about 1:100 to about 100:1.

In another embodiment, the weight ratio of L-glufosinate, salts, esters, or combinations thereof and the additional herbicide ranges from about 1:75 to about 75:1.

In still another embodiment, the weight ratio of L-glufosinate, salts, esters, or combinations thereof and the additional herbicide is in the range from about 1:50 to about 50:1.

In still another embodiment, the weight ratio of L-glufosinate, salts, esters, or combinations thereof and the additional herbicide is in the range from about 1:25 to about 25:1.

In still another embodiment, the weight ratio of L-glufosinate, salts, esters, or combinations thereof and the additional herbicide is in the range from about 1:10 to about 10:1.

In a preferred embodiment, the weight ratio of L-glufosinate, salts, esters, or combinations thereof and the additional herbicide is in the range from about 1:5 to about 5:1.

In an embodiment, the weight ratio of L-glufosinate, salts, esters, or combinations thereof and at least one cellulose synthesis inhibitor herbicide is in the range from about 1:5 to about 5:1.

In an embodiment, the weight ratio of L-glufosinate, salts, esters, or combinations thereof and at least one very-long-chain fatty acid inhibitor herbicide is in the range from about 1:5 to about 5:1.

In an embodiment, the weight ratio of L-glufosinate, salts, esters, or combinations thereof and at least one hydroxyphenyl pyruvate dioxygenase inhibitor herbicide is in the range from about 1:5 to about 5:1.

In an embodiment, the weight ratio of L-glufosinate, salts, esters, or combinations thereof and at least one acetyl CoA carboxylase inhibitor herbicide is in the range from about 1:5 to about 5:1.

In an embodiment, the weight ratio of L-glufosinate, salts, esters, or combinations thereof and at least one herbicide with unknown mode of action is in the range from about 1:5 to about 5:1.

In a preferred embodiment, the weight ratio of L-glufosinate ammonium and indaziflam is about 1:1.78.

In a preferred embodiment, the weight ratio of L-glufosinate ammonium and pyroxasulfone is about 1:1.78.

In a preferred embodiment, the weight ratio of L-glufosinate ammonium and propisochlor is about 1:2.57.

In a preferred embodiment, the weight ratio of L-glufosinate ammonium and S-metolachlor is about 1:3.42.

In a preferred embodiment, the weight ratio of L-glufosinate ammonium and isoxaflutole is about 1:2.67.

In a preferred embodiment, the weight ratio of L-glufosinate ammonium and mesotrione is about 1:1.71.

In a preferred embodiment, the weight ratio of L-glufosinate ammonium and tembotrione is about 1:1.5.

In a preferred embodiment, the weight ratio of L-glufosinate ammonium and quizalofop-ethyl is about 1:0.17.

In a preferred embodiment, the weight ratio of L-glufosinate ammonium and quizalofop-p-tefuryl is about 1:0.42.

In a preferred embodiment, the weight ratio of L-glufosinate ammonium and napropamide is about 1:1.6.

In an embodiment, at least one additional herbicide which can be combined with L-glufosinate, salts, esters, or combinations thereof is selected from the group comprising:
(a) cellulose synthesis inhibitor herbicide;
(b) very-long-chain fatty acid (VLCFA) inhibitor herbicide;
(c) hydroxyphenyl pyruvate dioxygenase (HPPD) inhibitor herbicide;
(d) acetyl CoA carboxylase (ACC) inhibitor herbicide; and
(e) herbicide with unknown mode of action;
or combinations thereof.

In another aspect, there is provided use of a synergistic herbicidal combination for controlling Brachiaria genus weeds.

In another aspect, there is provided use of a synergistic herbicidal combination comprising L-glufosinate, salts, esters, or combinations thereof and at least one additional herbicide, for controlling Brachiaria genus weeds.

In another aspect, there is provided use of a synergistic herbicidal combination comprising L-glufosinate ammonium and at least one additional herbicide, for controlling Brachiaria genus weeds.

In another aspect, there is provided use of a synergistic herbicidal combination for controlling Brachiaria genus weeds, wherein said combination comprises:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

In another aspect, there is provided use of a synergistic herbicidal combination for controlling Brachiaria genus weeds, wherein said combination comprises:
(a) L-glufosinate ammonium; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

The herbicidal combinations of the present disclosure can be used in agricultural lands such as fields, paddy fields, lawns and orchards or in non-agricultural lands. The present disclosure may be used to control diseases in agricultural lands for cultivating the plants without any phytotoxicity to the plant.

In an embodiment, the present disclosure provides a method for controlling weeds by applying a herbicidal combination comprising:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof;
wherein the weeds comprise Brachiaria genus weeds.

In another aspect the present disclosure provides a method of controlling Brachiaria genus weeds at a locus, the method comprising applying a synergistic herbicidal combination comprising L-glufosinate, salts, esters, or combinations thereof and at least one additional herbicide selected from the group comprising:
(a) cellulose synthesis inhibitor herbicides;
(b) very-long-chain fatty acid (VLCFA) inhibitor herbicides;
(c) hydroxyphenyl pyruvate dioxygenase (HPPD) inhibitor herbicides;
(d) acetyl CoA carboxylase (ACC) inhibitor herbicides; and
(e) herbicides with unknown mode of action;
or combinations thereof.

In an embodiment the method comprises application of present herbicidal combinations to a locus of a plant, wherein Brachiaria genus weeds occurs or are expected to occur.

In an embodiment, the method of controlling Brachiaria genus weeds comprises applying at a locus thereof, a synergistic herbicidal combination comprising L-glufosinate, salts, esters, or combinations thereof and at least one additional herbicide, wherein L-glufosinate, salts, esters, or combinations thereof is applied at an application rate of about 1 g a.i./ha to about 3000 g a.i./ha.

In an embodiment, L-glufosinate, salts, esters, or combinations thereof is applied at an application rate of about 1 g a.i./ha to about 2000 g a.i./ha.

In an embodiment, L-glufosinate, salts, esters, or combinations thereof is applied at an application rate of about 50 g a.i./ha to about 1000 g a.i./ha.

In an embodiment, L-glufosinate, salts, esters, or combinations thereof is applied at an application rate of about 50 g a.i./ha to about 500 g a.i./ha.

In an embodiment, L-glufosinate, salts, esters, or combinations thereof is applied at an application rate of about 50 g a.i./ha to about 350 g a.i./ha.

In a preferred embodiment, L-glufosinate ammonium in the herbicidal combination is applied at an application rate of about 150 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the group comprising:
(a) cellulose synthesis inhibitor herbicide applied at an application rate from about 10 g a.i./ha to about 300 g a.i./ha;
(b) very-long-chain fatty acid inhibitor herbicide applied at an application rate from about 50 g a.i./ha to about 1000 g a.i./ha;
(c) hydroxyphenyl pyruvate dioxygenase inhibitor herbicide applied at an application rate from about 10 g a.i./ha to about 450 g a.i./ha;
(d) acetyl CoA carboxylase inhibitor herbicide applied at an application rate from about 5 g a.i./ha to about 300 g a.i./ha; and
(e) herbicides with unknown mode of action applied at an application rate from about 100 g a.i./ha to about 800 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the cellulose synthesis inhibitor herbicide, wherein the cellulose synthesis inhibitor herbicide is applied at an application rate of about 1 g a.i./ha to about 300 g a.i./ha.

In an embodiment, the cellulose synthesis inhibitor herbicide in the present combination is applied at an application rate of about 1 g a.i./ha to about 300 g a.i./ha.

In an embodiment, the cellulose synthesis inhibitor herbicide in the present combination is applied at an application rate of about 10 g a.i./ha to about 300 g a.i./ha.

In a preferred embodiment, indaziflam in the present combination is applied at an application rate of about 50 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the very-long-chain fatty acid (VLCFA) inhibitor herbicide, wherein the very-long-chain fatty acid (VLCFA) inhibitor herbicide is applied at an application rate of about 1 g a.i./ha to about 1500 g a.i./ha.

In an embodiment, the very-long-chain fatty acid (VLCFA) inhibitor herbicide in the present combinations is applied at an application rate of about 1 g a.i./ha to about 1200 g a.i./ha.

In an embodiment, the very-long-chain fatty acid (VLCFA) inhibitor herbicide in the present combinations is applied at an application rate of about 50 g a.i./ha to about 1000 g a.i./ha.

In a preferred embodiment, pyroxasulfone in the present combination is applied at an application rate of about 75 g a.i./ha.

In a preferred embodiment, propisochlor in the present combination is applied at an application rate of about 540 g a.i./ha.

In a preferred embodiment, S-metolachlor in the present combination is applied at an application rate of about 960 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the hydroxyphenyl pyruvate dioxygenase (HPPD) inhibitor herbicide, wherein the hydroxyphenyl pyruvate dioxygenase (HPPD) inhibitor herbicide is applied at an application rate of about 1 g a.i./ha to about 500 g ai/ha.

In an embodiment, the hydroxyphenyl pyruvate dioxygenase (HPPD) inhibitor herbicide in the present combinations is applied at an application rate of about 10 g a.i./ha to about 450 g a.i./ha.

In an embodiment, the hydroxyphenyl pyruvate dioxygenase (HPPD) inhibitor herbicide in the present combinations is applied at an application rate of about 10 g a.i./ha to about 150 g a.i./ha.

In a preferred embodiment, isoxaflutole in the present combination is applied at an application rate of about 60 g a.i./ha.

In a preferred embodiment, mesotrione in the present combination is applied at an application rate of about 100 g a.i./ha.

In a preferred embodiment, tembotrione in the present combination is applied at an application rate of about 53 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the acetyl CoA carboxylase (ACC) inhibitor herbicide, wherein the acetyl CoA carboxylase (ACC) inhibitor herbicide is applied at an application rate of about 1 g a.i./ha to about 500 g a.i./ha.

In an embodiment, the acetyl CoA carboxylase (ACC) inhibitor herbicide in the present combinations is applied at an application rate of about 1 g a.i./ha to about 450 g a.i./ha.

In an embodiment, the acetyl CoA carboxylase (ACC) inhibitor herbicide in the present combinations is applied at an application rate of about 5 g a.i./ha to about 300 g a.i./ha.

In an embodiment, the acetyl CoA carboxylase (ACC) inhibitor herbicide in the present combinations is applied at an application rate of about 1 g a.i./ha to about 80 g a.i./ha.

In a preferred embodiment, quizalofop-ethyl in the present combination is applied at an application rate of about 25 g a.i./ha.

In a preferred embodiment, quizalofop-p-tefuryl in the present combination is applied at an application rate of about 25 g a.i./ha.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the herbicides with unknown mode of action, wherein the herbicide with unknown mode of action is applied at an application rate of about 1 g a.i./ha to about 1000 g a.i./ha.

In an embodiment, the amount of herbicide with unknown mode of action in the present combinations is applied at an application rate of about 1 g a.i./ha to about 900 g a.i./ha.

In an embodiment, the amount of herbicide with unknown mode of action in the present combinations is applied at an application rate of about 100 g a.i./ha to about 800 g a.i./ha.

In an embodiment, the amount of herbicide with unknown mode of action in the present combinations is applied at an application rate of about 100 g a.i./ha to about 700 g a.i./ha.

In a preferred embodiment, napropamide in the present combination is applied at an application rate of about 675 g a.i./ha.

In an embodiment, the combinations and methods disclosed herein can be used to control undesired vegetation in a variety of crop and non-crop applications. In some embodiments, the compositions and methods disclosed herein can be used for controlling undesired vegetation in crops.

Examples of the crops on which the combinations according to the present disclosure may be used include, but are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., Asteraceae vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In a preferred embodiment, the Brachiaria genus weed is Brachiaria decumbens.

In another aspect, there is provided a synergistic herbicidal composition for controlling Brachiaria genus weeds.

In another aspect, there is provided a synergistic herbicidal composition comprising L-glufosinate, salts, esters, or combinations thereof and at least one additional herbicide, for controlling Brachiaria genus weeds.

In another aspect, there is provided a synergistic herbicidal composition comprising L-glufosinate ammonium and at least one additional herbicide, for controlling Brachiaria genus weeds.

In another embodiment, the present disclosure provides a herbicidal composition for controlling Brachiaria genus weeds, said composition comprising:
(a) L-glufosinate, salts, esters, or combinations thereof; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

In another embodiment, the present disclosure provides a herbicidal composition for controlling Brachiaria genus weeds, said composition comprising:
(a) L-glufosinate ammonium; and
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof.

In an embodiment, the method of controlling Brachiaria genus weeds comprises applying to a locus thereof a synergistic herbicidal composition comprising L-glufosinate, salts, esters, or combinations thereof and at least one additional herbicide, wherein L-glufosinate, salts, esters, or combinations thereof is present in an amount in the range from about 100 g a.i./L to about 1000 g a.i./L.

In an embodiment, the amount of L-glufosinate, salts, esters, or combinations thereof is present in an amount from about 100 g a.i./L to about 500 g a.i./L.

In an embodiment, the amount of L-glufosinate, salts, esters, or combinations thereof is present in an amount from about 100 g a.i./L to about 400 g a.i./L.

In an embodiment, the L-glufosinate, salts, esters, or combinations thereof is present in an amount in the range from about 180 g a.i./L to about 380 g a.i./L.

In an embodiment, the L-glufosinate, salts, esters, or combinations thereof is present in an amount in the range from about 250 g a.i./L to about 300 g a.i./L.

In an embodiment, the amount of L-glufosinate ammonium present in the herbicide composition is in the range from about 250 g a.i./L to about 300 g a.i./L.

In one preferred embodiment, the L-glufosinate, salts, esters, or combinations thereof is present in an amount of about 280 g a.i./L.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the cellulose synthesis inhibitor herbicide, wherein the cellulose synthesis inhibitor herbicide is present in an amount in the range from about 1 g a.i./L to about 1000 g a.i./L.

In an embodiment, the amount of cellulose synthesis inhibitor herbicide in the combination, composition or methods of the present disclosure is in the range from about 100 g a.i./L to about 900 g a.i./L.

In an embodiment, the amount of cellulose synthesis inhibitor herbicide is in the range from about 100 g a.i./L to about 800 g a.i./L.

In an embodiment, the amount of cellulose synthesis inhibitor herbicide is in the range from about 100 g a.i./L to about 700 g a.i./L.

In an embodiment, the amount of cellulose synthesis inhibitor herbicide is in the range from about 100 g a.i./L to about 600 g a.i./L.

In a preferred embodiment, the amount of indaziflam present in the herbicide composition is in the range of about 500 g a.i./L.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the very-long-chain fatty acid (VLCFA) inhibitor herbicide, wherein the very-long-chain fatty acid inhibitor herbicide is present in an amount in the range from about 1 g a.i./L to about 2000 g a.i./L.

In an embodiment, the amount of the very-long-chain fatty acid inhibitor herbicide in the combination, composition or methods of the present disclosure is in the range from about 1 g a.i./L to about 1000 g a.i./L.

In an embodiment, the amount of the very-long-chain fatty acid inhibitor herbicide in the combination, composition or methods of the present disclosure is in the range from about 100 g a.i./L to about 1000 g a.i./L.

In an embodiment, the amount of the very-long-chain fatty acid inhibitor herbicide in the combination, composition or methods of the present disclosure is in the range from about 400 g a.i./L to about 1000 g a.i./L.

In a preferred embodiment, the amount of pyroxasulfone present in the herbicide composition is in the range of about 500 g a.i./L.

In a preferred embodiment, the amount of propisochlor present in the herbicide composition is in the range of about 720 g a.i./L.

In a preferred embodiment, the amount of S-metolachlor present in the herbicide composition is in the range of about 960 g a.i./L.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the hydroxyphenyl pyruvate dioxygenase (HPPD) inhibitor herbicide, wherein the hydroxyphenyl pyruvate dioxygenase (HPPD) inhibitor herbicide is present in an amount in the range from about 1 g a.i./L to about 1000 g a.i./L.

In an embodiment, the amount of the hydroxyphenyl pyruvate dioxygenase (HPPD) inhibitor herbicide in the combination, composition or methods of the present disclosure is in the range from about 100 g a.i./L to about 900 g a.i./L.

In an embodiment, the amount of the hydroxyphenyl pyruvate dioxygenase inhibitor herbicide in the combination, composition or methods of the present disclosure is in the range from about 300 g a.i./L to about 900 g a.i./L.

In an embodiment, the amount of the hydroxyphenyl pyruvate dioxygenase inhibitor herbicide in the combination, composition or methods of the present disclosure is in the range from about 300 g a.i./L to about 600 g a.i./L.

In an embodiment, the amount of the hydroxyphenyl pyruvate dioxygenase inhibitor herbicide in the combination, composition or methods of the present disclosure is in the range from about 300 g a.i./L to about 500 g a.i./L.

In a preferred embodiment, the amount of isoxaflutole present in the herbicide composition is in the range of about 750 g a.i./L.

In a preferred embodiment, the amount of mesotrione present in the herbicide composition is in the range of about 480 g a.i./L.

In a preferred embodiment, the amount of tembotrione present in the herbicide composition is in the range of about 420 g a.i./L.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the acetyl CoA carboxylase (ACC) inhibitor herbicide, wherein the acetyl CoA carboxylase (ACC) inhibitor herbicide is present in an amount in the range from about 1 g a.i./L to about 500 g a.i./L.

In an embodiment, the amount of the acetyl CoA carboxylase (ACC) inhibitor herbicide in the combination, composition or methods of the present disclosure is in the range from about 1 g a.i./L to about 400 g a.i./L.

In an embodiment, the amount of the acetyl CoA carboxylase (ACC) inhibitor herbicide in the combination, composition or methods of the present disclosure is in the range from about 10 g a.i./L to about 300 g a.i./L.

In an embodiment, the amount of the acetyl CoA carboxylase (ACC) inhibitor herbicide in the combination, composition or methods of the present disclosure is in the range from about 10 g a.i./L to about 200 g a.i./L.

In an embodiment, the amount of the acetyl CoA carboxylase (ACC) inhibitor herbicide used in the combination, composition or methods of the present disclosure is in the range from about 10 g a.i./L to about 100 g a.i./L.

In a preferred embodiment, the amount of quizalofop-ethyl present in the herbicide composition is in the range of about 50 g a.i./L.

In a preferred embodiment, the amount of quizalofop-p-tefuryl present in the herbicide composition is in the range of about 120 g a.i./L.

In another embodiment, the present disclosure provides a method of controlling Brachiaria genus weeds, the method comprising applying at a locus thereof a synergistic herbicidal combination comprising L-glufosinate, salts, esters, or combinations thereof and at least one additional herbicide selected from the herbicides with unknown mode of action, wherein the herbicide with unknown mode of action is present in an amount in the range from about 1 g a.i./L to about 1000 g a.i./L.

In an embodiment, the amount of herbicide with unknown mode of action in the present combinations is in the range from about 100 g a.i./L to about 900 g a.i./L.

In an embodiment, the amount of herbicide with unknown mode of action in the present combinations is in the range from about 100 g a.i./L to about 800 g a.i./L.

In an embodiment, the amount of herbicide with unknown mode of action in the present combinations is in the range from about 100 g a.i./L to about 700 g a.i./L.

In an embodiment, the amount of herbicide with unknown mode of action in the present combinations is in the range from about 100 g a.i./L to about 600 g a.i./L.

In an embodiment, the amount of herbicide with unknown mode of action in the present combinations is in the range from about 100 g a.i./L to about 500 g a.i./L.

In a preferred embodiment, the amount of napropamide present in the herbicide composition is in the range of about 450 g a.i./L.

In an embodiment, the herbicidal combination is applied jointly, or separately, or sequentially, or simultaneously to a plant or a locus thereof to control from about 50% to about 100% of the weeds.

In an embodiment, the present invention provides L-glufosinate, salts, esters, or combinations thereof in combination with at least one additional herbicide, wherein the combination controls from about 50% to about 100% of the weeds.

In an embodiment, the present invention provides the use of L-glufosinate, salts, esters, or combinations thereof applied at a rate of about 150 g a.i./ha, in combination with at least one additional herbicide applied in a range from about 10 g a.i./ha to about 1000 g a.i./ha, wherein the combination controls from about 50% to about 100% of the weeds.

In an embodiment, the present invention provides the use of L-glufosinate, salts, esters, or combinations thereof applied at a rate of about 150 g a.i./ha, in combination with S-metalochlor applied at a rate of about 960 g a.i./ha for controlling Brachiaria decumbens, wherein the combination controls from about 70% to about 85% of the weed at or within 7 to 28 days after application (DAA).

In an embodiment, the present invention provides the use of L-glufosinate, salts, esters, or combinations thereof applied at a rate of about 150 g a.i./ha, in combination with Indaziflam applied at a rate of about 50 g a.i./ha for controlling Brachiaria decumbens, wherein the combination controls from about 90% to about 100% of the weed at or within 7 to 21 days after application (DAA).

In an embodiment, the present invention provides the use of L-glufosinate, salts, esters, or combinations thereof applied at a rate of about 150 g a.i./ha, in combination with Isoxaflutole applied at a rate of about 60 g a.i./ha for controlling Brachiaria decumbens, wherein the combination controls from about 90% to about 100% of the weed at or within 7 to 28 days after application (DAA).

In an embodiment, the present invention provides the use of L-glufosinate, salts, esters, or combinations thereof applied at a rate of about 150 g a.i./ha, in combination with Pyroxasulfone applied at a rate of about 75 g a.i./ha for controlling Brachiaria decumbens, wherein the combination controls from about 75% to about 85% of the weed at or within 7 to 28 days after application (DAA).

In an embodiment, the present invention provides the use of L-glufosinate, salts, esters, or combinations thereof applied at a rate of about 150 g a.i./ha, in combination with Napropamide applied at a rate of about 675 g a.i./ha for controlling Brachiaria decumbens, wherein the combination controls from about 90% to about 100% of the weed at or within 7 to 28 days after application (DAA).

In an embodiment, the present invention provides the use of L-glufosinate, salts, esters, or combinations thereof applied at a rate of about 150 g a.i./ha, in combination with Propisochlor applied at a rate of about 540 g a.i./ha for controlling Brachiaria decumbens, wherein the combination controls from about 85% to about 100% of the weed at or within 7 to 28 days after application (DAA).

In an embodiment, the present invention provides the use of L-glufosinate, salts, esters, or combinations thereof applied at a rate of about 150 g a.i./ha, in combination with Tembotrione applied at a rate of about 53 g a.i./ha for controlling Brachiaria decumbens, wherein the combination controls of about 50% of the weed at or within 3 days after application (DAA).

In an embodiment, the present invention provides the use of L-glufosinate, salts, esters, or combinations thereof applied at a rate of about 150 g a.i./ha, in combination with Quizalofop-ethyl applied at a rate of about 25 g a.i./ha for controlling Brachiaria decumbens, wherein the combination controls of about 80% of the weed at or within 28 to 35 days after application (DAA).

In an embodiment, the present invention provides the use of L-glufosinate, salts, esters, or combinations thereof applied at a rate of about 150 g a.i./ha, in combination with Quizalofop-p-tefuryl applied at a rate of about 25 g a.i./ha for controlling Brachiaria decumbens, wherein the combination controls from about 80% to about 82% of the weed at or within 14 to 35 days after application (DAA).

In an embodiment, the present invention provides the use of L-glufosinate, salts, esters, or combinations thereof applied at a rate of about 150 g a.i./ha, in combination with Mesotrione applied at a rate of about 100 g a.i./ha for controlling Brachiaria decumbens, wherein the combination controls of about 50% of the weed at or within 3 days after application (DAA).

In an embodiment, the herbicidal compositions according to the present disclosure for controlling Brachiaria genus weeds, comprises at least one agrochemically suitable excipients/additive in addition to herbicidal combination comprising L-glufosinate, salts, esters, or combinations thereof and at least one additional herbicide.

In an embodiment, the present disclosure provides a herbicidal composition for controlling Brachiaria genus weeds, said composition comprising:
(a) L-glufosinate, salts, esters, or combinations thereof;
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof; and
(c) at least one agrochemically acceptable excipient.

In a preferred embodiment, Brachiaria genus weeds is Brachiaria decumbens.

In an embodiment, the present disclosure provides a herbicidal composition for controlling Brachiaria genus weeds, said composition comprising:
(a) L-glufosinate ammonium;
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof; and
(c) at least one agrochemically acceptable excipient.

In an embodiment, the present combinations/compositions can further comprise one or more co-herbicides.

The examples of co-herbicides that can be combined with present herbicidal combinations include, but are not limited to, tetflupyrolimet, dioxopyritrione, rimisoxafen, benquitrione, bipyrazone, cypyrafluone, fenpyrazone, tripyrasulfone, anisiflupurin, beflubutamid, bixlozone, SL-1201, cyclopyranil, dimesulfazet, epyrifenacil, topramezone, orthosulfamuron, pinoxaden, metamifop, pyrimisulfan, tembotrione, thiencarbazone methyl, flucetosulfuron, aminopyralid, pyrasulfotole, saflufenacil, pyroxsulam, pyroxasulfone, pyraclonil, indaziflam, fenquinotrione, tiafenacil, cinmethylin, lancotrione-sodium, bixlozone, trifludimoxazin, cyclopyrimorate, methiozolin, aminocyclopyrachlor, metazosulfuron, ipfencarbazone, fenoxasulfone, bicyclopyrone, triafamone, halauxifen methyl and tolpyralate.

In an embodiment, the agrochemically acceptable excipients/carriers/additives comprise at least one co-solvent(s), surfactant(s), water, colorant(s), dispersant(s), emulsifier(s), thickener(s), antifreeze agent(s), biocide(s), anti-foam agent(s), stabilizer(s), wetting agent(s), or combinations thereof.

In an embodiment, the surfactant(s) may be selected from non-ionic, anionic, cationic surfactants, or combinations thereof.

In an embodiment, the examples of non-ionic surfactants comprise polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, or combinations thereof.

In an embodiment, the examples of anionic surfactants comprise alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates, or combinations thereof.

In an embodiment, the cationic surfactants comprise alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates, or combinations thereof.

In an embodiment, the emulsifier(s) which can be advantageously employed herein can be readily determined by those skilled in the art and comprise various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether, or combinations thereof.

In an embodiment, the colorant(s) comprise iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum, zinc, or combinations thereof.

Another embodiment involves addition of a thickener or binder which may be selected from the group comprising molasses, granulated sugar, alginates, karaya gum, jaguar gum, tragacanth gum, polysaccharide gum, mucilage, xanthan gum, or combinations thereof. In another embodiment, the binder may be selected from the group comprising silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols, or combinations thereof.

In another embodiment, an antifreeze agent(s) added to the composition may be alcohols selected from the group comprising ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol, or combinations thereof.

According to an embodiment, the biocide(s) comprise benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, or combinations thereof.

According to an embodiment, the antifoam agent(s) comprise polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable and animal fats, sulfates of vegetable and animal fat, vegetable and animal oils, sulfates of vegetable and animal oils, vegetable and animal waxes, sulfates of vegetable and animal waxes, agents based on silicon or magnesium stearate, or combinations thereof.

According to an embodiment, representative organic liquids which can be employed in preparing an emulsifiable concentrates include, for example, the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of an emulsifiable concentrate. The formulations can also contain other compatible additives, for example, plant growth regulators and other biologically active compounds used in agriculture.

According to an embodiment, representative organic liquids which can be employed in preparing an emulsifiable concentrates include, for example, the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of an emulsifiable concentrate. The formulations can also contain other compatible additives, for example, plant growth regulators and other biologically active compounds used in agriculture.

According to an embodiment, the agrochemical formulation may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA (Ethylenediaminetetraacetic acid), EGTA (Ethylenebis(oxyethylenenitrilo)tetraacetic acid), phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to an embodiment, the mixtures of the aforementioned antioxidants are possible.

According to an embodiment, the examples of solvents are water, aromatic solvents (for example xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones, N-Methyl-2-pyrrolidone (NMP), N-Ethyl-2 pyrrolidone (NEP), N-Octyl-2-pyrrolidone (NOP), acetates (glycol diacetate), glycols, fatty acid dimethylamides, fatty acids and fatty acid esters, isophorone and dimethylsulfoxide, or combinations thereof.

According to an embodiment, solvent mixtures may also be used.

According to an embodiment, exemplary surfactants comprise alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose, or combinations thereof.

According to an embodiment, examples of carriers comprise mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, urea, and products of vegetable origin, such as cereal meal, tree bark meal, wood meal and nutshell meal, cellulose powders, polyvinylpyrrolidone and other solid carriers, or combinations thereof.

According to an embodiment, exemplary preservatives comprise 1,2-benzisothiazolin-3-one and/or 2-Methyl-2H-isothiazol-3-one or sodium benzoate or benzoic acid, or combinations thereof.

In another aspect, present compositions may further comprise at least safener.

In an embodiment the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetylhexahydro-3,3,8α-trimethylpyrrolo[1,2-α]pyrimidin-6-(2H-one) (BAS-145138), dichloromethyl-1,3-dioxolane (MG-191), quinolinyloxyacetate compounds, or agriculturally acceptable salts, esters, or combinations thereof.

In an embodiment, the composition may be present in any agrochemically suitable form for storage and application to the ground. The compositions may be produced by mixing the actives in the composition with an inert carrier and adding surfactants and other adjuvants and carriers as needed and formulated into solid or liquid formulations, comprising wettable powders (WP), granules (GR), dusts, soluble (liquid) concentrates (SL), suspension concentrates (SC), oil in water emulsion (EW), water in oil emulsion (EO), emulsifiable concentrates (EC), capsule suspensions (CS), mixed formulation of CS and SC (ZC) formulations, oil dispersions (OD), other known formulation types, or combinations thereof. The composition may also be used for treatment of a plant propagation material, such as seeds, etc.

The herbicidal combinations and compositions of the present disclosure can be in any conventional agriculturally useful form, for example, in a form of a ready-to-use formulation (premix or ready-mix), or in a form of a tank mix.

In an embodiment, compositions/combinations of the present disclosure may be applied either pre-emergence or post-emergence. Advantageously, the compositions/combinations of the present disclosure provide significant and improved control of weeds, when applied in post-emergence stage.

In an embodiment, the method for controlling target weeds comprises applying the premix formulation or tank-mix formulation comprising L-glufosinate, salts, esters, or combinations thereof and at least one additional herbicide, at the desired locus.

In an embodiment, the method for controlling target weeds comprises applying the premix formulation or tank-mix formulation comprising L-glufosinate ammonium and at least one additional herbicide, at the desired locus.

In an embodiment, the combination or tank-mix formulation comprising L-glufosinate, salts, esters, or combinations thereof and at least one additional herbicide further comprises at least one co-herbicide.

In an embodiment, each individual composition may further comprise one or more agrochemically acceptable excipient/ingredients. The resulting combination or tank-mix formulation of the composition comprising L-glufosinate, salts, esters, or combinations thereof, at least one additional herbicide, and at least one co-herbicide provides a synergistic effect in controlling Brachiaria genus weeds.

In an embodiment, the herbicides of the combinations of the present disclosure maybe applied simultaneously as a tank mix or in a formulation or may be applied sequentially. The sequential application may be in immediate succession or with a time gap and may be carried in any order as deemed to be effective by the person skilled in the art. The application may be made to the soil before emergence of the plants, either pre-planting or post-planting. The application may be made to the soil after emergence of the plants. The application may be made as a foliar spray at different timings during crop development, with either one or more applications early or late post-emergence. Herbicidal compositions according to the disclosure can also be incorporated into the soil before, during or after sowing seeds of a crop.

These combinations as described above may be applied to the locus of the weeds, in an herbicidally effective amount.

In an embodiment, the combinations or the compositions comprising L-glufosinate or L-glufosinate salts according to the present disclosure may be used for burndown application or fallow application.

In an embodiment, the method comprises applying composition comprising L-glufosinate, salts, esters, or combinations thereof and at least one additional herbicide as a tank mix.

In an embodiment, the method comprises applying tank mix composition comprising L-glufosinate, salts, esters, or combinations thereof and at least one additional herbicide selected from the group comprising:
(a) cellulose synthesis inhibitor herbicides;
(b) very-long-chain fatty acid (VLCFA) inhibitor herbicides;
(c) hydroxyphenyl pyruvate dioxygenase (HPPD) inhibitor herbicides;
(d) acetyl CoA carboxylase (ACC) inhibitor herbicides; and
(e) herbicides with unknown mode of action;
or combinations thereof.

In an embodiment, the method comprises applying composition comprising L-glufosinate, salts, esters, or combinations thereof and at least one additional herbicide as a premix.

In an embodiment, the method comprises applying the present combinations or compositions simultaneously, that is jointly or separately, or in succession.

In an embodiment, the method comprises applying in immediate succession the combination comprising L-glufosinate, salts, esters, or combinations thereof and at least one additional herbicide.

The compositions of the present disclosure may be applied in any known ways or conventional methods known to a person skilled in art. Non limiting examples of such methods are foliar spray, basal barking, stem injection, drill and fill method, axe cut method, cut stump, cut and swab, stem scraper, wick application and so forth. The compositions of the present disclosure are used in the customary manner, for example by watering, spraying, atomizing, dusting or scattering. Said compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In some embodiments, wherein the undesirable and harmful vegetation is treated post-emergence, the compositions disclosed herein are applied by foliar application.

In accordance with present disclosure the method of control of target weeds may be carried out by spraying the suggested tank mixes, or the individual herbicides may be formulated as a kit-of-parts containing various components that may be mixed as instructed prior to spraying.

In an embodiment, the present disclosure provides a kit-of-parts comprising L-glufosinate, salts, esters, or combinations thereof and another component of an additional herbicide or herbicides. The kit-of-parts may additionally comprise a component comprising one or more agrochemically acceptable ingredients. The kit-of-parts may additionally be accompanied with a set of instructions for mixing or use of the components provided therein.

According to an embodiment, the kit of parts comprises:
(a) L-glufosinate, salts, esters, or combinations thereof;
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof; and
(c) at least one agrochemically acceptable excipient;
and optionally further comprises:

(d) instructions for use.

According to an embodiment, the kit of parts comprises:
(a) L-glufosinate ammonium;
(b) at least one additional herbicide selected from the group comprising cellulose synthesis inhibitor herbicides, very-long-chain fatty acid (VLCFA) inhibitor herbicides, hydroxyphenyl pyruvate dioxygenase (HPPD) inhibitor herbicides, acetyl CoA carboxylase (ACC) inhibitor herbicides, herbicides with unknown mode of action, or combinations thereof; and
(c) at least one agrochemically acceptable excipient;
and optionally further comprises:
(d) instructions for use.

In an embodiment, the present disclosure provides a method of increasing yield in a crop by application of a synergistic herbicidal combination comprising L-glufosinate, salts, esters, or combinations thereof and at least one additional herbicide, as described herein.

In an embodiment, the present disclosure provides a method of improving the plant health by application of a synergistic herbicidal combination comprising L-glufosinate, salts, esters, or combinations thereof and at least one additional herbicide, as described herein.

The herbicidal combinations/compositions of the present disclosure are highly safe to crop plants and capable of controlling target weeds problematic in e.g., paddy fields, upland fields or non-agricultural fields over a wide range of from pre-emergency to post-emergence.

In view of the above, it will be seen that the several advantages of the disclosure are achieved, and other advantageous results are attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be combined together to exhibit the teaching of the invention, without departing from the scope of the disclosure.

The present disclosure is more particularly described in the following examples that are intended as illustration only, since numerous modifications and variations within the scope of the present disclosure will be apparent to those of skill in the art. The disclosure should therefore not be limited by the above-described embodiment, method, and following examples, but by all embodiments and methods within the scope and spirit of the disclosure.

The following examples illustrates the composition, underlying effect and basic methodology of the present disclosure.

### EXAMPLES

The following products were used for evaluating the weed control efficacy of present herbicidal combinations.

TABLE 6
Herbicidal combinations

| | Dose | Dose |
|---|---|---|
| Active ingredient | (g a.i./L) | (g a.i/ha) |
| L-glufosinate ammonium | 280 | 150 |
| (Glufosinate-P-ammonium) | | |
| Indaziflam | 500 | 50 |
| S-metolachlor | 960 | 960 |
| Isoxaflutole | 750 | 60 |
| Pyroxasulfone | 500 | 75 |
| Tembotrione | 420 | 53 |
| Propisochlor | 720 | 540 |
| Napropamide | 450 | 675 |
| Quizalofop-ethyl | 50 | 25 |
| Quizalofop-p-tefuryl | 120 | 25 |
| Mesotrione | 480 | 100 |

### Evaluation of Post-Emergence Herbicidal Activity:

Methodology: Trials were conducted to evaluate the efficacy of the combinations comprising L-glufosinate ammonium and the additional herbicides on Brachiaria genus weeds.

The soil used was sandy clay loam—sand: 68.0%; silt: 8.0%; clay: 24.0%.

All treatments were in 4 replications per treatment with a spray volume of about 150 L/ha.

Efficacy Evaluation: The expected efficacy of a combination comprising L-glufosinate ammonium and additional herbicides was calculated using the well-established Colby method. Any difference between the observed and expected efficacy could be attributed to synergy exhibited by the combination.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967(15), p. 20-22). The Colby method requires only a single dose of each herbicide applied alone and the mixture of both doses. The formula used to calculate the expected efficacy (EE) which was compared with the observed efficacy (OE) to determine the efficacy of the present disclosure is explained hereinbelow:

The expected efficacy for a combination of two active ingredients is as follows:

$$EE = ( A + B - ( A \times B ) / 100 )$$

wherein,
A=Observed efficacy of active ingredient A at the same concentration as used in the mixture.
B=Observed efficacy of the active ingredient B at the same concentration as used in the mixture.

### Example 1: Efficacy of Combination L-Glufosinate Ammonium and S-Metolachlor on Brachiaria decumbens

Experiment was conducted to assess the efficacy of the herbicidal combination comprising L-glufosinate ammonium (glufosinate-P-ammonium) and S-metolachlor to control the weed, Brachiaria decumbens.

Table 7 demonstrates synergy in efficacy observed on the weeds using the combination comprising L-glufosinate ammonium and S-metolachlor. The percentage efficacy was calculated after 7, 14, 21 and 28 days of applications (DAA). The target weed was Brachiaria decumbens, and the concentration of the herbicide and the results are recorded in the Table 7.

TABLE 7
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate- | efficacy (%) of | S-metolachlor | S-metolachlor |
| application | P-ammonium) | S-metolachlor | (150 + 960 g | (150 + 960 g |
| (DAA) | (150 g a.i./ha) | (960 g a.i./ha) | a.i./ha) | a.i./ha) |
| 7 | 65 | 0 | 65 | 80 |
| 14 | 70 | 0 | 70 | 85 |
| 21 | 70 | 0 | 70 | 80 |
| 28 | 60 | 0 | 60 | 70 |

*Expected efficacy according to Colby's Formula

Therefore, synergy was observed in the control of weed Brachiaria decumbens by application of herbicidal combination comprising L-glufosinate ammonium and S-metolachlor.

### Example 2: Efficacy of Combination L-Glufosinate Ammonium and Indaziflam on Brachiaria decumbens

Experiment was conducted to assess the efficacy of the herbicidal combination comprising L-glufosinate ammonium (glufosinate-P-ammonium) and indaziflam to control the weed, Brachiaria decumbens.

Table 8 demonstrates synergy in efficacy observed on the weeds using the combination comprising L-glufosinate ammonium and indaziflam. The percentage efficacy was calculated after 7, 14 and 21 days of applications (DAA). The target weed was Brachiaria decumbens, and the concentration of the herbicide and the results are recorded in the Table 8.

TABLE 8
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate- | efficacy (%) of | Indaziflam | Indaziflam |
| application | P-ammonium) | Indaziflam | (150 + 50 g | (150 + 50 g |
| (DAA) | (150 g a.i./ha) | (50 g a.i./ha) | a.i./ha) | a.i./ha) |
| 7 | 75 | 50 | 87.5 | 90 |
| 14 | 65 | 75 | 91.25 | 100 |
| 21 | 60 | 90 | 96 | 100 |

*Expected efficacy according to Colby's Formula

Therefore, synergy was observed in the control of weed Brachiaria decumbens by application of herbicidal combination comprising L-glufosinate ammonium and Indaziflam.

### Example 3: Efficacy of Combination L-Glufosinate Ammonium and Isoxaflutole on Brachiaria decumbens

Experiment was conducted to assess the efficacy of the herbicidal combination comprising L-glufosinate ammonium (glufosinate-P-ammonium) and isoxaflutole to control the weed, Brachiaria decumbens.

Table 9 demonstrates synergy in efficacy observed on the weeds using the combination comprising L-glufosinate ammonium and isoxaflutole. The percentage efficacy was calculated after 7, 14, 21 and 28 days of applications (DAA). The target weed was Brachiaria decumbens, and the concentration of the herbicide and the results are recorded in the Table 9.

TABLE 9
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate- | efficacy (%) of | Isoxaflutole | Isoxaflutole |
| application | P-ammonium) | Isoxaflutole | (150 + 60 g | (150 + 60 g |
| (DAA) | (150 g a.i./ha) | (60 g a.i./ha) | a.i./ha) | a.i./ha) |
| 7 | 70 | 45 | 83.5 | 90 |
| 14 | 65 | 70 | 89.5 | 100 |
| 21 | 60 | 85 | 94 | 100 |
| 28 | 60 | 75 | 90 | 100 |

*Expected efficacy according to Colby's Formula

Therefore, synergy was observed in the control of weed Brachiaria decumbens by application of herbicidal combination comprising L-glufosinate ammonium and Isoxaflutole.

### Example 4: Efficacy of Combination L-Glufosinate Ammonium and Pyroxasulfone on Brachiaria decumbens

Experiment was conducted to assess the efficacy of the herbicidal combination comprising L-glufosinate ammonium (glufosinate-P-ammonium) and pyroxasulfone to control the weed, Brachiaria decumbens.

Table 10 demonstrates synergy in efficacy observed on the weeds using the combination comprising L-glufosinate ammonium and pyroxasulfone. The percentage efficacy was calculated after 7, 14, 21 and 28 days of applications (DAA). The target weed was Brachiaria decumbens, and the concentration of the herbicide and the results are recorded in the Table 10.

TABLE 10
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate- | efficacy (%) of | Pyroxasulfone | Pyroxasulfone |
| application | P-ammonium) | Pyroxasulfone | (150 + 75 g | (150 + 75 g |
| (DAA) | (150 g a.i./ha) | (75 g a.i./ha) | a.i./ha) | a.i./ha) |
| 7 | 65 | 0 | 65 | 75 |
| 14 | 70 | 15 | 74.5 | 85 |
| 21 | 70 | 25 | 77.5 | 85 |
| 28 | 60 | 20 | 68 | 85 |

* Expected efficacy according to Colby's Formula

Therefore, synergy was observed in the control of weed Brachiaria decumbens by application of herbicidal combination comprising L-glufosinate ammonium and Pyroxasulfone.

### Example 5: Efficacy of Combination L-Glufosinate Ammonium and Napropamide on Brachiaria decumbens

Experiment was conducted to assess the efficacy of the herbicidal combination comprising L-glufosinate ammonium (glufosinate-P-ammonium) and napropamide to control the weed, Brachiaria decumbens.

Table 11 demonstrates synergy in efficacy observed on the weeds using the combination comprising L-glufosinate ammonium and napropamide. The percentage efficacy was calculated after 7, 14, 21 and 28 days of applications (DAA). The target weed was Brachiaria decumbens, and the concentration of the herbicide and the results are recorded in the Table 11.

TABLE 11
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate-P- | efficacy (%) of | napropamide | napropamide |
| application | ammonium) | napropamide | (150 + 675 g | (150 + 675 g |
| (DAA) | (150 g a.i./ha) | (675 g a.i./ha) | a.i./ha) | a.i./ha) |
| 7 | 75 | 5 | 76.25 | 90 |
| 14 | 85 | 5 | 85.75 | 100 |
| 21 | 85 | 5 | 85.75 | 100 |
| 28 | 85 | 0 | 85 | 100 |

*Expected efficacy according to Colby's Formula

Therefore, synergy was observed in the control of weed Brachiaria decumbens by application of herbicidal combination comprising L-glufosinate ammonium and Napropamide.

### Example 6: Efficacy of Combination L-Glufosinate Ammonium and Propisochlor on Brachiaria decumbens

Experiment was conducted to assess the efficacy of the herbicidal combination comprising L-glufosinate ammonium (glufosinate-P-ammonium) and propisochlor to control the weed, Brachiaria decumbens.

Table 12 demonstrates synergy in efficacy observed on the weeds using the combination comprising L-glufosinate ammonium and propisochlor. The percentage efficacy was calculated after 7, 14, 21 and 28 days of applications (DAA). The target weed was Brachiaria decumbens, and the concentration of the herbicide and the results are recorded in the Table 12.

TABLE 12
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (glufosinate- | (glufosinate- |
| | ammonium | Observed | P-ammonium) + | P-ammonium) + |
| Days after | (glufosinate-P- | efficacy (%) of | Propisochlor | Propisochlor |
| application | ammonium) | Propisochlor | (150 + 540 g | (150 + 540 g |
| (DAA) | (150 g a.i./ha) | (540 g a.i./ha) | a.i./ha) | a.i./ha) |
| 7 | 65 | 0 | 65 | 85 |
| 14 | 70 | 0 | 70 | 100 |
| 21 | 70 | 0 | 70 | 100 |
| 28 | 60 | 0 | 60 | 100 |

*Expected efficacy according to Colby's Formula

Therefore, synergy was observed in the control of weed Brachiaria decumbens by application of herbicidal combination comprising L-glufosinate ammonium and Propisochlor.

### Example 7: Efficacy of Combination L-Glufosinate Ammonium and Tembotrione on Brachiaria decumbens

Experiment was conducted to assess the efficacy of the herbicidal combination comprising L-glufosinate ammonium (glufosinate-P-ammonium) and tembotrione to control the weed, Brachiaria decumbens.

Table 13 demonstrates synergy in efficacy observed on the weeds using the combination comprising L-glufosinate ammonium and tembotrione. The percentage efficacy was calculated after 3 days of applications (DAA). The target weed was Brachiaria decumbens, and the concentration of the herbicide and the results are recorded in the Table 13.

TABLE 13
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | | ammonium | ammonium |
| | L-glufosinate | | (Glufosinate- | (Glufosinate- |
| | ammonium | Observed | P-ammonium) + | P-ammonium) + |
| Days after | (Glufosinate-P- | efficacy (%) of | tembotrione | tembotrione |
| application | ammonium) | tembotrione | (150 + 53 g | (150 + 53 g |
| (DAA) | (150 g a.i./ha) | (53 g a.i./ha) | a.i./ha) | a.i./ha) |
| 3 | 40 | 8 | 44.8 | 50 |

*Expected efficacy according to Colby's Formula

Therefore, synergy was observed in the control of weed Brachiaria decumbens by application of herbicidal combination comprising L-glufosinate ammonium and Tembotrione.

### Example 8: Efficacy of Combination L-Glufosinate Ammonium and Quizalofop-Ethyl on Brachiaria decumbens

Experiment was conducted to assess the efficacy of the herbicidal combination comprising L-glufosinate ammonium (glufosinate-P-ammonium) and quizalofop-ethyl to control the weed, Brachiaria decumbens.

Table 14 demonstrates synergy in efficacy observed on the weeds using the combination comprising L-glufosinate ammonium and quizalofop-ethyl. The percentage efficacy was calculated after 28 and 35 days of applications (DAA). The target weed was Brachiaria decumbens, and the concentration of the herbicide and the results are recorded in the Table 14.

TABLE 14
Efficacy observed on Brachiaria decumbens

| | | | Expected | Observed |
|---|---|---|---|---|
| | | | Efficacy* | Efficacy |
| | | | (%) of L- | (%) of L- |
| | | | glufosinate | glufosinate |
| | Observed | | ammonium | ammonium |
| | efficacy (%) of | | (Glufosinate- | (Glufosinate- |
| | L-glufosinate | Observed | P-ammonium) + | P-ammonium) + |
| | ammonium | efficacy (%) of | quizalofop- | quizalofop- |
| Days after | (Glufosinate-P- | quizalofop- | ethyl | ethyl |
| application | ammonium) | ethyl | (150 + 25 g | (150 + 25 g |
| (DAA) | (150 g a.i./ha) | (25 g a.i./ha) | a.i./ha) | a.i./ha) |
| 28 | 60 | 35 | 74 | 80 |
| 35 | 55 | 30 | 68.5 | 80 |

*Expected efficacy according to Colby's Formula

Therefore, synergy was observed in the control of weed Brachiaria decumbens by application of herbicidal combination comprising L-glufosinate ammonium and Quizalofop-ethyl.

### Example 9: Efficacy of Combination L-Glufosinate Ammonium and Quizalofop-p-Tefuryl on Brachiaria decumbens

Experiment was conducted to assess the efficacy of the herbicidal combination comprising L-glufosinate ammonium (glufosinate-P-ammonium) and quizalofop-p-tefuryl to control the weed, Brachiaria decumbens.

Table 15 demonstrates synergy in efficacy observed on the weeds using the combination comprising L-glufosinate ammonium and quizalofop-p-tefuryl. The percentage efficacy was calculated after 14, 21, 28 and 35 days of applications (DAA). The target weed was Brachiaria decumbens, and the concentration of the herbicide and the results are recorded in the Table 15.

TABLE 15
Efficacy observed on Brachiaria decumbens

| | | | Expected | Observed |
|---|---|---|---|---|
| | | | Efficacy* | Efficacy |
| | | | (%) of L- | (%) of L- |
| | | | glufosinate | glufosinate |
| | Observed | | ammonium | ammonium |
| | efficacy (%) of | | (Glufosinate- | (Glufosinate- |
| | L-glufosinate | Observed | P-ammonium) + | P-ammonium) + |
| | ammonium | efficacy (%) of | quizalofop- | quizalofop- |
| Days after | (Glufosinate-P- | quizalofop-p- | p-tefuryl | p-tefuryl |
| application | ammonium) | tefuryl | (150 + 25 g | (150 + 25 g |
| (DAA) | (150 g a.i./ha) | (25 g a.i./ha) | a.i./ha) | a.i./ha) |
| 14 | 75 | 20 | 80 | 82 |
| 21 | 70 | 10 | 73 | 80 |
| 28 | 60 | 5 | 62 | 80 |
| 35 | 55 | 5 | 57.25 | 80 |

*Expected efficacy according to Colby's Formula

Therefore, synergy was observed in the control of weed Brachiaria decumbens by application of herbicidal combination comprising L-glufosinate ammonium and Quizalofop-p-tefuryl.

### Example 10: Efficacy of Combination L-Glufosinate Ammonium and Mesotrione on Brachiaria decumbens

Experiment was conducted to assess the efficacy of the herbicidal combination comprising L-glufosinate ammonium (glufosinate-P-ammonium) and mesotrione to control the weed, Brachiaria decumbens.

Table 16 demonstrates synergy in efficacy observed on the weeds using the combination comprising L-glufosinate ammonium and mesotrione. The percentage efficacy was calculated after 3 days of applications (DAA). The target weed was Brachiaria decumbens, and the concentration of the herbicide and the results are recorded in the Table 16.

TABLE 16
Efficacy observed on Brachiaria decumbens

| | | | Expected | Observed |
|---|---|---|---|---|
| | | | Efficacy* | Efficacy |
| | | | (%) of L- | (%) of L- |
| | Observed | | glufosinate | glufosinate |
| | efficacy (%) of | Observed | ammonium + | ammonium + |
| Days after | L-glufosinate | efficacy (%) of | mesotrione | mesotrione |
| application | ammonium | mesotrione | (150 + 100 g | (150 + 100 g |
| (DAA) | (150 g a.i./ha) | (100 g a.i./ha) | a.i./ha) | a.i./ha) |
| 3 | 40 | 10 | 46 | 50 |

*Expected efficacy according to Colby's Formula

Therefore, synergy was observed in the control of weed Brachiaria decumbens by application of herbicidal combination comprising L-glufosinate ammonium and Mesotrione.

The results represented in above examples in Tables 7 to 16 clearly demonstrate synergy between L-glufosinate ammonium and additional herbicides. The difference between the observed and the expected efficacy clearly demonstrates the synergistic effect of the present herbicidal combination.

1. A method for controlling weeds by applying a herbicidal combination comprising:
(a) L-glufosinate, salts, esters, or combinations thereof; and
(b) at least one additional herbicide selected from the group consisting of cellulose synthesis inhibitor herbicides, very-long-chain fatty acid inhibitor herbicides, hydroxyphenyl pyruvate dioxygenase inhibitor herbicides, acetyl CoA carboxylase inhibitor herbicides, herbicides with unknown mode of action, and combinations thereof;
wherein the weeds comprise Brachiaria genus weeds.

2. The method as claimed in claim 1, wherein the salt comprises an inorganic salt of L-glufosinate.

3. The method as claimed in claim 2, wherein the inorganic salt of L-glufosinate is selected from the group consisting of L-glufosinate sodium, L-glufosinate potassium, L-glufosinate ammonium, and combinations thereof.

4. The method as claimed in claim 1, wherein
(a) the cellulose synthesis inhibitor herbicide is indaziflam;
(b) the very-long-chain fatty acid inhibitor herbicide is selected from the group comprising pyroxasulfone, propisochlor, metolachlor, S-metolachlor, or combinations thereof;
(c) the hydroxyphenyl pyruvate dioxygenase inhibitor herbicide is selected from the group comprising isoxaflutole, mesotrione, tembotrione, or combinations thereof;
(d) the acetyl CoA carboxylase inhibitor herbicide is selected from the group comprising quizalofop-ethyl, quizalofop-p-tefuryl, or combinations thereof; and
(e) the herbicide with unknown mode of action is selected from the group comprising napropamide, napropamide-M, or combinations thereof.

5. The method as claimed in claim 1, wherein a weight ratio of the L-glufosinate, salts, esters, or combinations thereof to the at least one additional herbicide is in a range from about 1:25 to about 25:1.

6. The method as claimed in claim 1, wherein an amount of L-glufosinate, salts, esters, or combinations thereof is in a range from about 100 g a.i./L to about 400 g a.i./L.

7. The method as claimed in claim 1, wherein
(a) the cellulose synthesis inhibitor herbicide is in a range from about 100 g a.i./L to about 700 g a.i./L;
(b) the very-long-chain fatty acid inhibitor herbicide is in a range from about 400 g a.i./L to about 1000 g a.i./L;
(c) the hydroxyphenyl pyruvate dioxygenase inhibitor herbicide is in a range from about 300 g a.i./L to about 900 g a.i./L;
(d) the acetyl CoA carboxylase inhibitor herbicide is in a range from about 10 g a.i./L to about 300 g a.i./L; and
(e) the herbicide with unknown mode of action is in a range from about 100 g a.i./L to about 700 g a.i./L.

8. The method as claimed in claim 1, wherein the L-glufosinate, salts, esters, or combinations thereof is applied at an application rate from about 50 g a.i./ha to about 350 g a.i./ha.

9. The method as claimed in claim 1, wherein
(a) the cellulose synthesis inhibitor herbicide is applied at an application rate from about 10 g a.i./ha to about 300 g a.i./ha;
(b) the very-long-chain fatty acid inhibitor herbicide is applied at an application rate from about 50 g a.i./ha to about 1000 g a.i./ha;
(c) the hydroxyphenyl pyruvate dioxygenase inhibitor herbicide is applied at an application rate from about 10 g a.i./ha to about 450 g a.i./ha;
(d) the acetyl CoA carboxylase inhibitor herbicide is applied at an application rate from about 5 g a.i./ha to about 300 g a.i./ha; and
(e) the herbicide with unknown mode of action is applied at an application rate from about 100 g a.i./ha to about 800 g a.i./ha.

10. The method as claimed in claim 1, wherein the Brachiaria genus weed is selected from the group comprising Brachiaria africana, Brachiaria coracana, Brachiaria floccifolia, Brachiaria decumbens, Brachiaria intermedia, Brachiaria jaegeri, Brachiaria kigeziensis, Brachiaria multiflora, Brachiaria semisterilis, Brachiaria tristachya, or combinations thereof.

11. The method as claimed in claim 1, wherein the combination is applied jointly, or separately, or sequentially, or simultaneously to a plant or locus thereof to control from about 50% to about 100% of the weeds.

12. (canceled)

13. A herbicidal combination for controlling Brachiaria genus weeds, the combination comprising:
(a) L-glufosinate, salts, esters, or combinations thereof; and
(b) at least one additional herbicide selected from the group consisting of cellulose synthesis inhibitor herbicides, very-long-chain fatty acid inhibitor herbicides, hydroxyphenyl pyruvate dioxygenase inhibitor herbicides, acetyl CoA carboxylase inhibitor herbicides, herbicides with unknown mode of action, and combinations thereof.

14. A herbicidal composition for controlling Brachiaria genus weeds, the composition comprising:
(a) L-glufosinate, salts, esters, or combinations thereof;
(b) at least one additional herbicide selected from the group consisting of cellulose synthesis inhibitor herbicides, very-long-chain fatty acid inhibitor herbicides, hydroxyphenyl pyruvate dioxygenase inhibitor herbicides, acetyl CoA carboxylase inhibitor herbicides, herbicides with unknown mode of action, and combinations thereof; and
(c) at least one agrochemically acceptable excipient.
